(19) United States
(12) Patent Application Publication
(10) Pub. No.: US 2003/0095603 A1
(43) Pub. Date: May 22, 2003

(54) Reduced-complexity video decoding using larger pixel-grid motion compensation

(75) Inventors: Tse-Hua Lan, Taipei (TW); Yingwei Chen, Beijing (CN)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/996,004

(22) Filed: Nov. 16, 2001

(51) Int. Cl. H04N 7/12

(52) U.S. Cl. 375/240.17; 375/240.12; 375/240.16; 375/240.03; 375/240.2

(57) ABSTRACT

A method and system for reducing computation complexity of an MPEG digital video decoder system by scaling down the computation of motion compensation during the decoding process are provided. The video processing system processes incoming MPEG video signals including a plurality of macroblocks with a motion vector associated therewith. A non full-pel vector is converted to a full-pel motion vector on a P frame and a B frame, or on a combination of P and B frames, by rounding an odd number vector to the nearest even number vector. Then, a motion compensated MPEG video picture is performed based on the converted full-pel motion vector. As a result, a. substantial computational overhead associated with interpolation is desirably avoided.

### BACKGROUND OF THE INVENTION

1. Field of the Invention

The present invention relates to an image processing of compressed video information, and more particularly to a method and system for regulating the computation load of an MPEG decoder.

2. Description of the Related Art

In order to improve transmission efficiency, images containing a huge amount of data are typically compressed then transmitted over a transmission medium to a decoder, which is operative to decode the coded video data. Thus, it is highly desirable to decode compressed video information quickly and efficiently in order to provide a motion video. One compression standard which has attained widespread use for compressing and decompressing video information is the Moving Pictures Expert Group (MPEG) standard for video encoding and decoding. The MPEG standard is defined in International Standard ISO/IEC 11172-1, “Information Technology—Coding of moving pictures and associated audio for digital storage media at up to about 1.5 Mbit/s”, Parts 1, 2, and 3, First edition 1993-08-01 which is hereby incorporated by reference in its entirety.

In general, the computation load of processing a frame is not constrained by the decoding algorithm in the MPEG2 decoding processor. However, due to the irregular computation load behavior of MPEG2 decoding, the peak computation load of a frame may exceed the maximum CPU load of a media processor, thereby causing frame drops or unexpected results. As a consequence, when an engineer implements MPEG2 decoding on a media processor, he or she needs to choose a processor that has a performance margin of 40%-50% above the average decoding computation load in order to have a smooth operation in the event that the peak computation load occurs. This type of implementation is uneconomical and creates a waste of resources as the undesirable peak computation load does not occur frequently.

In MPEG 2, a standard decoder always performs motion compensation (MC) according to the motion vector type and is one of the most computationally intensive operations in many common video decompression methods. The motion vectors define the movement of an object (i.e., a macroblock) in the video data from a reference frame to a current frame. Each motion vector consists of a horizontal component (“x”) and a vertical component (“y”). Each component represents the distance that the object has moved in time between the reference frame and the current frame. Accordingly, most MPEG2 decoders require a substantial computation load of processing a motion compensation operation, causing it to exceed the maximum CPU load of a media processor. Therefore, there is a need to provide a reduce decoding scheme that can reduce the MC operations in an MPEG2 decoder implemented on a media processor or power saving devices.

### SUMMARY OF THE INVENTION

The present invention is directed to a method and system for reducing computation complexity of an MPEG digital video decoder system by scaling down the computation of motion compensation during the decoding process.

According to an aspect of the present invention, the method includes the steps of: determining whether an MPEG video signal contains a non full-pel motion vector; if the MPEG video signal contains said non full-pel motion vector, converting the non full-pel vector to a full-pel motion vector by rounding an odd number vector to the nearest even number vector; and, producing a motion compensated MPEG video picture based on the converted full-pel motion vector. The non full-pel motion vector may be one of a quarter-pel motion vector, a half-pel motion vector, and a fractional-pel motion vector. The conversion of the non full-pel vector to the full-pel motion vector is performed on the P frame and the B frame, or on a combination of P and B frames.

According to another aspect of the invention, the method for improving the decoding efficiency of an encoded data video signal employing an MPEG digital video decoder of the type having a variable length code (VLC) decoder, an inverse quantizer (IQ), an inverse discrete cosine transformer (IDCT), a motion compensator (MC), and a complexity selector includes the steps of: receiving a compressed video data stream at the VLC decoder and producing decoded data therefrom; simultaneously, determining the type of motion vectors from the decoded data; dequantizing the decoded data using the IQ to generate dequantized, decoded data; employing the IDCT for transforming the dequantized, decoded data from a frequency domain to a spatial domain to produce difference data; employing the MC for performing a full-pel motion compensation on every macroblock regardless of the types of motion vectors to generate a reference data; and, combining the reference data and difference data to produce motion compensated pictures. The compressed video data stream may include a plurality of macroblocks formed of an array of the digital pixel data, and a full-pel motion compensation is performed on every macroblock regardless of the types of motion vectors.

According to a further aspect of the present invention, the system may include: a variable length decoder (VLD) configured to receive and decode a stream of MPEG video signals, where the VLD is operative to output quantized data from the decoded MPEG video signals; a complexity selector configured to detect a motion vector type from the decoded MPEG video signals and to convert the detected motion vector to a full-pel motion vector; an inverse quantizer (IQ) coupled to receive the output of VLD to operatively inverse quantize the quantized data received therein; an inverse discrete cosine transformer (IDCT) coupled to the output of IQ for transforming the dequantized data from a frequency domain to a spatial domain; a motion compensator (MC) coupled to the output of a complexity selector for performing a full-pel motion compensation regardless of the types of motion vectors; and, an adder for receiving output signals from the MC and the IDCT to form motion-compensated pictures.

The foregoing and other features and advantages of the invention will be apparent from the following, more detailed description of preferred embodiments as illustrated in the accompanying drawings in which reference characters refer to the same parts throughout the various views. The drawings are not necessarily to scale, the emphasis instead is placed upon illustrating the principles of the invention.

### BRIEF DESCRIPTION OF THE DRAWINGS

A more complete understanding of the method and apparatus of the present invention may be available by reference to the following detailed description when taken in conjunction with the accompanying drawings wherein:

FIG. 1 is a simplified block diagram illustrating the architecture of a video communication system whereto embodiments of the present invention are to be applied;

FIG. 2 illustrates the format of the macroblock-type information;

FIG. 3 is a conventional decoder used in the video communication system shown in FIG. 1;

FIG. 4 is a simplified block diagram of the decoder according to an embodiment of the present invention;

FIG. 5 is a graphical representation of the locations of the relevant reference image data according to an embodiment of the present invention; and,

FIG. 6 is a flow chart depicting the operation steps within the decoder of FIG. 3 in accordance with the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

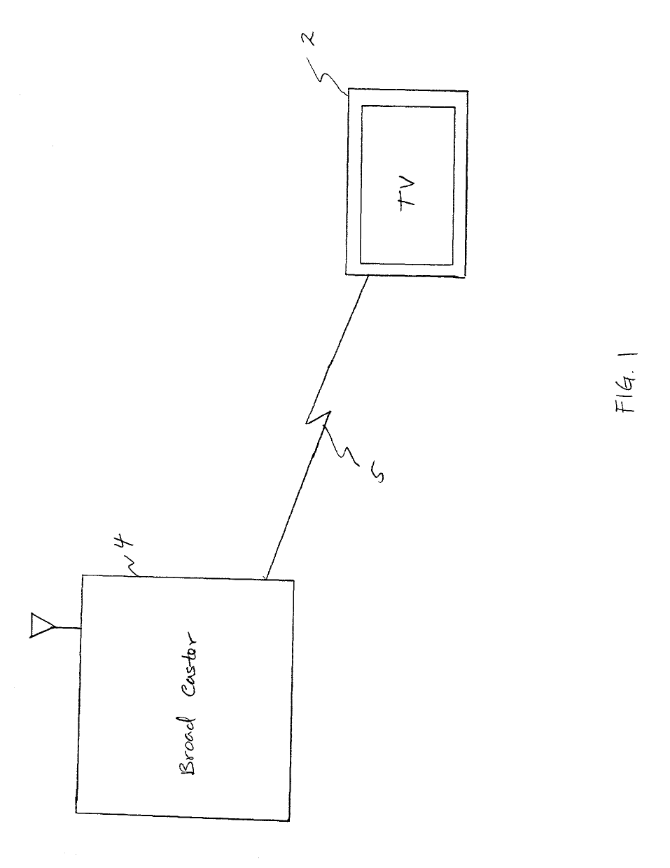

FIG. 1 illustrates an exemplary video communication system in which the present invention may be implemented. As shown in FIG. 1, the video communication system includes a digital television unit 2, a broadcaster 4, and a transmission medium 5. The preferred embodiment will be described in the context of a digital television system, such as a high-definition (HDTV) television system; however, it should be noted that the present invention can be used in other types of video equipment. The broadcaster 4 may be a television station or studio operative to send television signals to the digital television unit 2. The transmission medium 5 may be a conventional cable, coaxial cable, fiber-optic cable, a radio frequency (RF) link, or the like, over which television signals may be transmitted between the broadcaster 4 and digital television unit 2. The television signals comprised of video data, audio data, and control data are compressed or encoded at the transmitting end of the broadcaster 4 and decompressed in a bit stream by a decoder at the receiving end of the television unit 2 for a display.

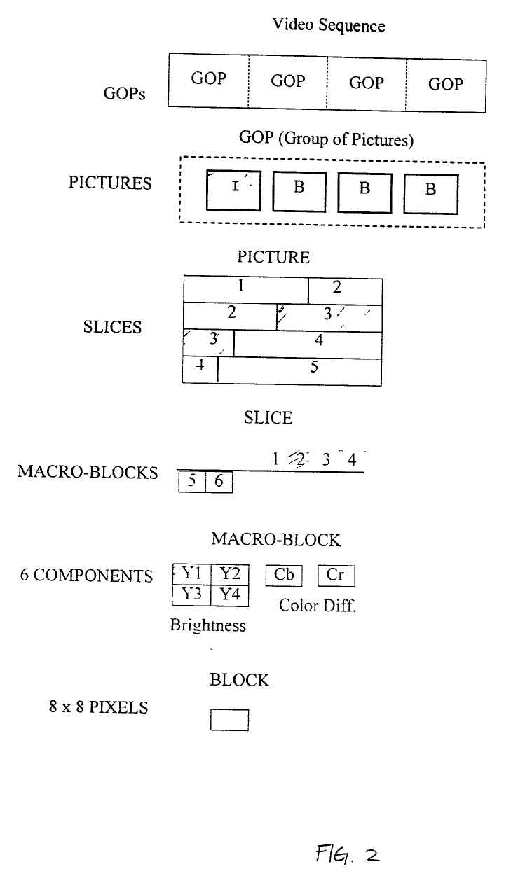

To facilitate an understanding of this invention, background information relating to MPEG2 coding will be described in conjunction with FIG. 2. As shown in FIG. 2, a hierarchical structure of the code format in accordance with the MPEG standard is shown. The top layer of the structure comprises a video sequence consisting of a plurality of GOPs (groups of pictures), where a picture corresponds to a sheet of image. Each picture is divided into a plurality of slices, and each slice consists of a plurality of macro-blocks disposed in a line from left to right and from top to bottom. Each of the macro-blocks consists of six components: four brightness components Y1 through Y4 representative of the brightness of four 8×8 pixel blocks constituting the macro-block of 16×16 pixels, and two colors (U, V) constituting difference components Cb and Cr of 8×8 pixel blocks for the same macro-block. Lastly, a block of 8×8 pixels is a minimum unit in video coding.

The MPEG2 coding is performed on an image by dividing the image into macroblocks of 16×16 pixels, each with a separate quantizer scale value associated therewith. The macro-blocks are further divided into individual blocks of 8×8 pixels. Each of 8×8 pixel blocks of the macro-blocks is subjected to a discrete cosine transform (DCT) to generate DCT coefficients for each of the 64 frequency bands therein. The DCT coefficients in an 8×8 pixel block are then divided by a corresponding coding parameter, i.e., a quantization weight. The quantization weights for a given 8×8 pixel block are expressed in terms of an 8×8 quantization matrix. Thereafter, additional calculations are effected on the DCT coefficients to take into account, namely the quantizer scale value, among other things, and thereby completing the MPEG2 coding. It should be noted that other coding techniques, such as JPEG or the like, may be used in the present invention.

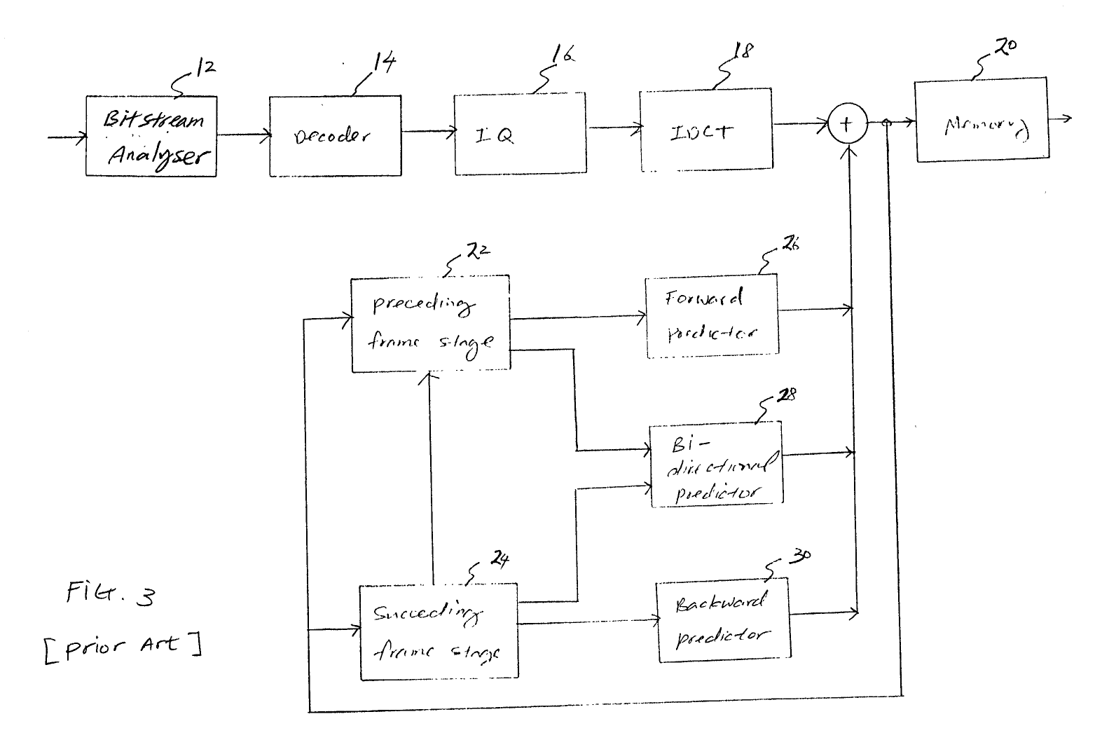

A conventional DCT-based image recovering from a bitstream coded by the means of a DCT-based coding method (or an MPEG bitstream) will be described with reference to FIG. 3. FIG. 3 depicts simplified circuit diagrams that are capable of recovering image codes from MPEG codes. Each of the codes or incoming bitstreams is analyzed to detect the type of code using a bitstream analyzer 12. In MPEG codes, the codes are divided into three types: (1) the intra-frame encoded codes defining an intra-coded picture as an I picture; (2) the inter-frame encoded codes that are predicted only from a preceding frame to constitute a predictive coded picture as a P picture; and, (3) the inter-frame encoded codes that are predicted from preceding and succeeding frames to constitute a bi-directionally predictive coded picture as a B picture. The I frame, or an actual video reference frame, is periodically coded, i.e., one reference frame for each of the fifteen frames. A prediction is made of the composition of a video frame, the P frame, to be located a specific number of frames forward and before the next reference frame. The B frame is predicted between the I frame and P frames, or by interpolating (averaging) a macroblock in the past reference frame with a macroblock in the future reference frame. The motion vector is also encoded, which specifies the relative position of a macroblock within a reference frame with respect to the macroblock within the current frame.

Referring back to FIG. 3, if the detected codes are of an I picture, the detected codes are decoded using a decoder 14 then inverse-quantized using an inverse quantizer 16. Thereafter, the values of pixels in blocks into which the picture has been divided are calculated by an inverse DCT processing using an inverse DCT (IDCT) block 18, whereafter the calculated values are forwarded and stored in a video memory 20 to display the picture. If the detected codes are of a P picture, the detected codes are decoded and inverse-quantized, then the differences of the blocks are calculated. Each difference is added by a forward predictor 26 to a corresponding motion-compensated block of a preceding frame stored in a preceding frame stage 22, then the resultant expanded video data is written in a video memory 20 to display the image. If the detected codes are of a B picture, the detected codes are decoded and inverse-quantized. The differences of the blocks are calculated using the IDCT 18. At this time, each difference is added by a bi-directional predictor 18 or a backward predictor 30 to a corresponding motion-compensated block of a preceding frame stored in a preceding frame stage 22 and a motion-compensated block of a succeeding frame stored in a succeeding frame stage 24. The resultant expanded video data is then stored in the video memory 20 to display the image.

As described above, any video data following the international standard MPEG code can recover the image from MPEG codes. After the decoding process, the present invention provides a mechanism for reducing the computation of video decoding operation by scaling down the computation load of the motion compensation circuit. A key principle of the present invention is to simplify the MC algorithm by changing a lower-level pixel grid mode to a higher-level pixel grid mode during a motion compensation operation.

In motion-compensation based video coding, motion vectors can have integer values (i.e., full-pel coding) in which the values of pixels in the current frame are specified in terms of the value of actual pixels in the reference frame, or half-integer values (i.e., half-pel coding), quarter-integer values (i.e., quarter-pel coding), and fractional values (i.e., fractional-pel coding) in which the values of pixels in the current frame are specified in terms of “virtual” pixels that are interpolated from existing pixels in the reference frame. These types of coding systems are well-known to those of ordinary skill in the art; thus, descriptions thereof are omitted to avoid redundancy. The half-pel motion compensation as well as the quarter-pel and the frational-pel motion compensation are more computationally extensive than the full-pel motion compensation as the decoder has to interpolate a macroblock from the previous macroblock referenced by the motion vector using the half, quarter, fractional-pel grids, respectively.

In contrast, the decoder in accordance with the embodiment of the present invention is configured to perform the full-pel motion compensation on every macroblock regardless of the types of motion vectors. For example, if a motion vector is a half-pel vector, the inventive MC algorithm will convert the half-pel vector to a full-pel vector during motion compensation in both P and B frames or in B frames only. If the motion vector is a quarter-pel vector, the inventive MC algorithm will treat it as a full-pel vector, or optionally as a half-pel vector, in motion compensation in both P and B frames or in B frames only. By scaling down the motion vectors selectively to reduce the MC operations in a decoder, the present invention is able to use less CPU cycles and memory access during the decoding process, while providing good viewing quality to acceptable viewing quality.

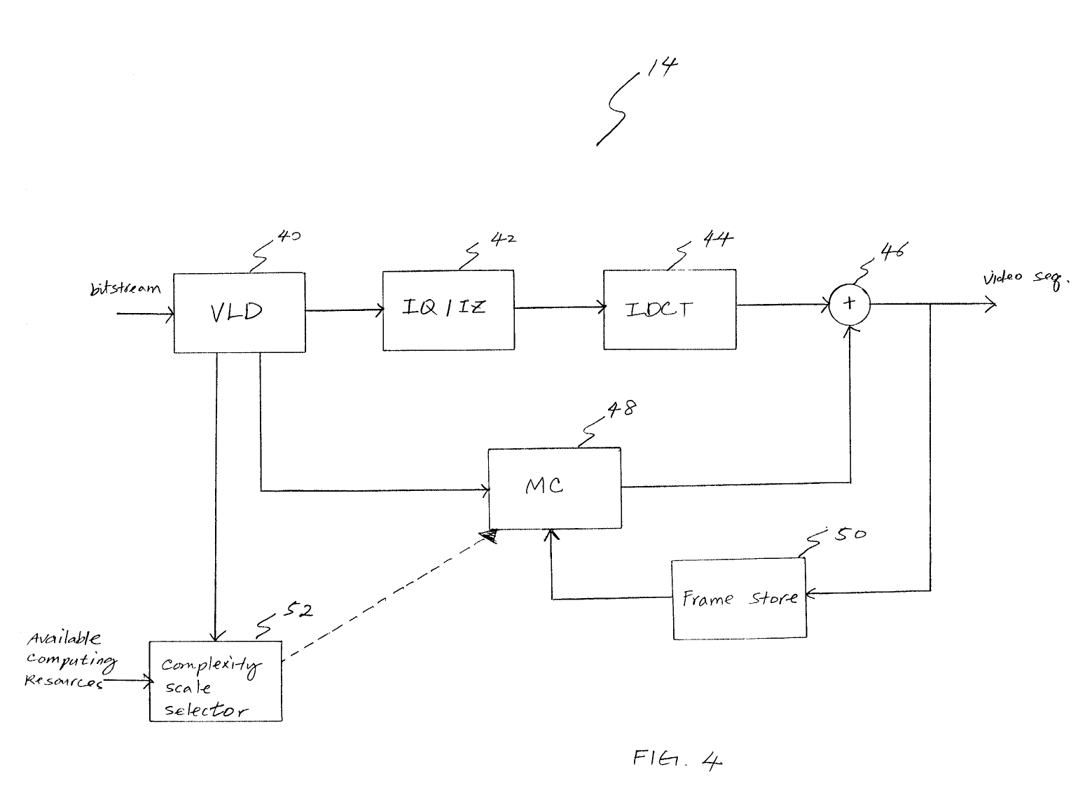

FIG. 4 illustrates the major components of a MPEG video decoder 14 that are capable of decoding incoming video signals according to an exemplary embodiment of the present invention. It is to be understood that the compression of incoming data is performed prior to arriving at the inventive decoder 14. Compressing video data is well known in the art that can be performed in a variety of ways—i.e., by discarding information to which the human visual system is insensitive in accordance with the standard set forth under the MPEG2 coding process. The MPEG video decoder 14 includes a variable length decoder (VLC) 40; an inverse scan/quantizer circuit 42; an inverse discrete cosine transform (IDCT) circuit 44; an adder 46; a motion compensation module 48; a frame storage 50; and, a complexity scale selector 52.

In operation, the decoder 14 receives a stream of compressed video information, which is provided to the VLC decoder 40. The VLC decoder 40 decodes the variable length coded portion of the compressed signal to provide a variable length decoded signal to the inverse scan (or zig-zag)/quantizer (IQ/IZ) circuit 42, which decodes the variable length decoded signal to provide a zig-zag decoded signal. The zig-zag decoded signal is provided to the inverse DCT circuit 44 as sequential blocks of information. This zig-zag decoded signal is then provided to the IDCT circuit 44, which performs an inverse discrete cosine transform on the zig-zag decoded video signal on a block by block basis to provide decompressed pixel values or decompressed error terms. The decompressed pixel values are provided to adder 46.

Meanwhile, the motion compensation circuit 48 receives motion information and provides motion-compensated pixels to adder 46 on a macroblock by macroblock basis. More specifically, forward motion vectors are used to translate pixels in previous pictures and backward motion vectors are used to translate pixels in future pictures. Then, this information is compensated by the decompressed error term provided by the inverse DCT circuit 44. Here, the motion compensation circuit 48 accesses the previous picture information and the future picture information from the frame storage 50. The previous picture information is then forward motion compensated by the motion compensation 48 to provide a forward motion-compensated pixel macroblock. The future picture information is backward motion compensated by the motion compensation circuit 48 to provide a backward motion-compensated pixel macroblock. The averaging of these two macroblocks yields a bidirectional motion compensated macroblock. Next, the adder 46 receives the decompressed video information and the motion-compensated pixels until a frame is completed. If the block does not belong to a predicted macroblock (for example, in the case of an I macroblock), then these pixel values are provided unchanged to the frame storage 50. However, for the predicted macroblocks (for example, B macroblocks and P macroblocks), the adder 46 adds the decompressed error to the forward motion compensation and backward motion compensation outputs from the motion compensation circuit 48 to generate the output pixel values.

The complexity scale selector 52 proves an estimation of computational loads within the motion compensation circuit 48. The function of the complexity scale selector 52 is to adjust the computation load current frame, slice, or macroblock before actually executing MPEG2 decoding blocks (except the VLD operation). That is, the inventive decoder 14 provides scalability by scaling down the motion vectors to a lower resolution so that less CPU cycles and memory usage of available computer resources, namely, the MC 48, are used. To accomplish this, the complexity scale selector 52 detects the incoming signals to adaptively control the computing complexity of the MC 24, so that a lesser computational burden is presented to the decoder 14 as described hereinafter.

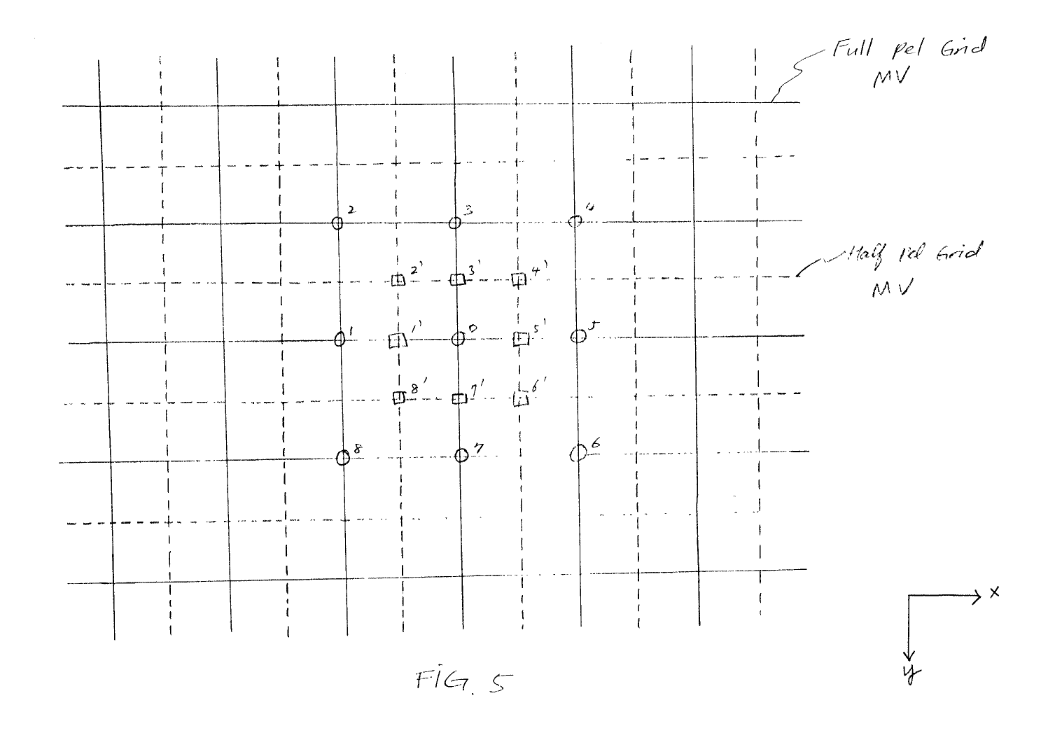

FIG. 5 shows a graphical representation of the locations of the relevant reference image data for both half-pel motion estimation (shown in dotted line) and full-pel motion estimation (shown in solid line). As shown in FIG. 5, location 1-8(circle) corresponds to the full-pel grid locations surrounding the location 0, and location 1′-8′ (square) corresponds to the half-pel locations surrounding the location 0. retinoic Upon examining the reference macroblocks that are on the sub-pixel level grid, the grids are promoted to the nearest even grid in the preferred embodiment. Alternatively, the grids may be promoted to the nearest odd grid, or may be promoted to either the nearest even grid or the nearest odd grid randomly. For example, if a half-pel motion vector (7, 2) is detected, the complexity scale selector 52 may promote it to a full-pel vector (6, 2) or (8, 2). If a half-pel motion vector (3, 5) is detected, the complexity scale selector 52 may promote it to a full-pel vector (2, 4), (4, 6) or (4, 4). This promotion rule is applied to P and B frames or B frames only in the preferred embodiment. After promoting all sub-pix level gird to the full-pel grid by the complexity scale selector 52, the motion compensation is executed by retrieving a macroblock from the previous macroblock referenced by the promoted full-pel motion vector, without generating any interpolated reference image data. Accordingly, the inventive MC algorithm avoids the computation load involved in implementing half-pel or quarter-pel motion estimation.

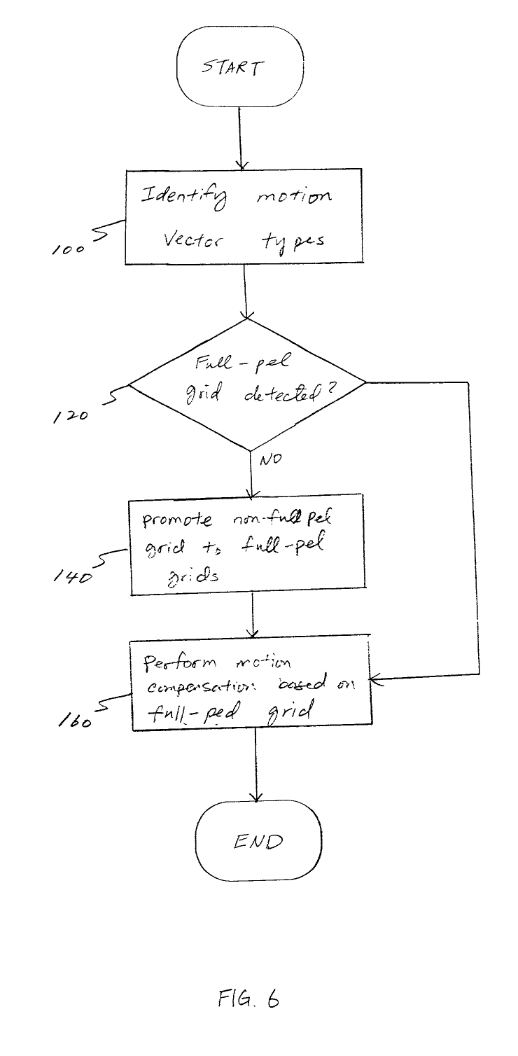

Although the present invention has been described mainly in the context of half-pel motion estimation, the present invention also can be applied to fractional-pel motion estimation algorithms by promoting more than one pel in either X or Y direction. Moreover, the present invention also can be embodied in the form of a program code embodied in tangible media, such as floppy diskettes, CD-ROMs, hard drives, or any other machine readable storage medium, wherein, when the program code is loaded into and executed by a machine, such as a computer, the machine becomes an apparatus for practicing the invention. Furthermore, the present invention can be embodied in the form of a program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The program code, when executed by the processor, causes the processor to perform the functions of the invention as described herein FIG. 6 is a flow diagram illustrating the processing performed by the present invention to provide a user recommendation. The rectangular elements indicate a computer software instruction, whereas the diamond-shaped element represents computer software instructions that affect the execution of the computer software instructions represented by the rectangular blocks. This flow chart is generally applicable to a hardware embodiment as well.

Initially, a stream of compressed video information is received by the inventive decoder 14. In step 100, the complexity scale selector 52 analyzes the format of macroblock-type information received therein and makes a determination on whether a full-pel grid is detected in step 120. That is to say, the complexity scale selector 52 determines different grades of performance for the MC 48 based on the current frame information and the available computing resources of the decoder 14. If the full-pel grid is detected, the motion compensation circuit 48 performs the motion compensation based on the full-gel grid without interpolation in step 160. However, if the full-pel grid is not detected, the non full-pel grid is promoted to full-pel grids in step 140. Thereafter, the motion compensation is performed by retrieving a macroblock from the previous marcroblock that is referenced by the full-pel motion vector in step 160.

While the preferred embodiments of the present invention have been illustrated and described, it will be understood by those skilled in the art that various changes and modifications may be made, and equivalents may be substituted for elements thereof without departing from the true scope of the present invention. Therefore, it is intended that the present invention not be limited to the particular embodiment disclosed as the best mode contemplated for carrying out the present invention, but that the present invention includes all embodiments falling within the scope of the appended claims.

What is claimed is:

1. A method for decoding an MPEG video signal for display, the method comprising the steps of:
determining whether said MPEG video signal contains a non full-pel motion vector;
if said MPEG video signal contains said non full-pel motion vector, converting said non full-pel vector to a full-pel motion vector; and,
producing a motion compensated MPEG video picture based on said converted full-pel motion vector.

2. The method of claim 1, wherein said non full-pel motion vector comprises one of a quarter-pel motion vector, a half-pel motion vector, and a fractional-pel motion vector.

3. The method of claim 1, further comprising producing a motion compensated MPEG video picture based on said full-pel motion vector if said MPEG video signal contains said full-pel motion vector.

4. The method of claim 1, further comprising decoding a compressed video data stream including a plurality of macroblocks formed of an array of the digital pixel data; and, performing a full-pel motion compensation on every macroblock regardless of the types of motion vectors.

5. The method of claim 1, wherein the step of converting said non full-pel vector to a full-pel motion vector further comprises rounding an odd number vector to the nearest even number vector.

6. The method of claim 1, wherein the step of converting said non full-pel vector to said full-pel motion vector is performed on one of P frame, B frame, and a combination of P and B frames.

7. A method for improving the decoding efficiency of an encoded data video signal employing an MPEG digital video decoder having a variable length code (VLD) decoder, an inverse quantizer (IQ), an inverse discrete cosine transformer (IDCT), a motion compensator (MC), and a complexity selector, the method comprising the steps of:
receiving a compressed video data stream having a motion vector associated therewith at said VLD and producing decoded data therefrom;
simultaneously, determining the type of motion vectors from said decoded data;
dequantizing said decoded data using said IQ to generate dequantized, decoded data;
employing said IDCT for transforming said dequantized, decoded data from a frequency domain to a spatial domain to produce difference data;
employing said MC for performing a full-pel motion compensation on every macroblock regardless of the types of motion vectors to generate a reference data; and,
combining said reference data and said difference data to produce motion compensated pictures.

8. The method of claim 7, wherein the step of determining the type of motion vectors from said decoded data further comprises determining whether the motion vector is one of a quarter-pel motion vector, a half-pel motion vector, and a fractional-pel motion vector.

9. The method of claim 8, further comprises converting the motion vector to a full motion vector.

10. The method of claim 9, wherein the step of converting the motion vector to said full-pel vector further comprises rounding an odd number vector to the nearest even number vector.

11. The method of claim 10, wherein the step of converting the motion vector to said full-pel motion vector is performed on one of P frame, B frame, and a combination of P and B frames.

12. A programmable video decoding system, comprising:
a variable length decoder (VLD) configured to receive and decode a stream of MPEG video signals with a motion vector associated therewith, said VLD being operative to output quantized data from said decoded MPEG video signals;
a complexity selector configured to detect a motion vector type from said decoded MPEG video signals and to convert said detected motion vector to a full-pel motion vector;
an inverse quantizer (IQ) coupled to receive the output of said VLD to operatively inverse quantize the quantized data received therein;
an inverse discrete cosine transformer (IDCT) coupled to the output of said IQ for transforming the dequantized data from a frequency domain to a spatial domain;
a motion compensator (MC) coupled to the output of said complexity selector for performing a full-pel motion compensation regardless of the types of motion vectors; and,
an adder for receiving output signals from said MC and said IDCT to form motion compensated pictures.

13. The system of claim 12, wherein the motion vector type comprises one of a quarter-pel motion vector, a half-pel motion vector, and a fractional-pel motion vector.

14. The system of claim 12, wherein said complexity selector converts the motion vector to said full-pel vector by rounding an odd number vector to the nearest even number vector.

15. The system of claim 10, wherein said complexity selector converts the motion vector to said full-pel vector on one of P frame, B frame, and a combination of P and B frames received therein.
